(19) United States
(12) Patent Application Publication
(10) Pub. No.: US 2012/0228000 A1
(43) Pub. Date: Sep. 13, 2012

(54) CONDUCTIVE ADHESIVE HAVING MULTIPLE CURVED LEAD WIRES THEREIN

(75) Inventor: Hsin-Lung WU, Taoyuan City (TW)

(73) Assignee: QUAN GEO ENTERPRISE CO., LTD., Taoyuan (TW)

(21) Appl. No.: 13/045,009

(22) Filed: Mar. 10, 2011

(51) Int. Cl. H01B 5/08

(52) U.S. Cl. 174/128.1

(57) ABSTRACT

A conductive adhesive having multiple curved lead wires therein serves as an electrical contact medium between an object to be tested and a test system or between objects to be connected. The conductive adhesive has a resilient body and multiple lead wires dispersedly mounted in the resilient body, extending from a bottom surface to a top surface of the resilient body, and being curved. A direction determined by two end points of each lead wire is perpendicular to the top surface of the resilient body. Attributable to a bendable nature of the lead wires, the pressing force during a pressing test and electrical connection can be reduced. The sideslip occurring on a bottom end of each lead wire can be also lessened so that the stability of the test and connection can be enhanced and an effective vertical operating stroke range is increased to facilitate various IC tests and electrical connection devices.

### BACKGROUND OF THE INVENTION

1. Field of the Invention

The present invention relates to an electrically conducting element having multiple lead wires therein used for integrated circuit (IC) tests and electrical connection devices, such as test sockets of IC components, wafer probe cards, electrical connection interfaces between circuit boards and the like, and more particularly to a conductive adhesive having multiple lead wires therein capable of cushioning a pressing force and reducing a sideslip effect on the lead wires.

2. Description of the Related Art

Conventional conductive adhesive films having multiple wires therein pertain to one kind of electrical contact medium used by test sockets of IC components, wafer probe cards and electrical connection interfaces and between objects to be tested and test systems or between objects to be connected. Each conductive adhesive film has multiple erected or slanted straight lead wires, for example, gold plated copper wires, distributed throughout a resilient adhesive to serve as electrical conductors and extending from a top surface to a bottom surface of the resilient adhesive.

Given an application to an IC component test system as an example, when being applied, the conductive adhesive film is mounted in a test socket on a load board of the test system, serves as a signal transmission interface between an object to be tested (i.e. an IC component) and the load board, and cushions a pressing force applied to the IC component by bending the resilient adhesive and part of the lead wires.

When the IC component is tested, the IC component is mounted in the test socket and is subjected to a pressing force. Each of the input terminals and output terminals, such as pin, pad or solder ball, abuts against a top end of at least one lead wire in the conductive adhesive film, and is connected to the test system through an electrical connection with a corresponding pad on the load board. The test system then tests the IC component to determine if the IC component functions correctly.

With reference to FIG. 15, when a conventional conductive adhesive film 6 is applied to an IC component test, multiple lead wires 60 in the conductive adhesive film 6 align obliquely. When the IC component 4 positioned above the conductive adhesive film 6 is pressed by the test system and the input or output terminals 40 further press down the conductive adhesive film 6, the slanted straight lead wires 60 are pressed and bent by the input or output terminals 40 so that the bottom ends of the lead wires 60 respectively contact with the pads 50 on the load board 5. As the lead wires 60 are slanted, bottom ends of the lead wires 60 easily sideslip on a top of the load board 5 or on tops of the pads 50. Such sideslip causes the lead wires 60 to have insufficient contact force with the pads 50 and leads to an unsatisfactory electrical contact that makes the conductive adhesive film uneasy to be correctly connected with the test system and affects the testing stability of the IC component.

To solve the sideslip occurring at the bottom ends of the pressed lead wires 60, technically, such issue can be resolved by making the lead wires 60 less slanted. However, the less slanted lead wires 60 require higher force exerted on the lead wires 60 to contact with the pads 50 on the load board 5, especially when the lead wires 60 align vertically. To achieve a proper compression stroke when the IC component presses down the conductive adhesive film 6, the required pressing force exceeds the capability of the existing test equipment and peripheral devices. Accordingly, change of inclination of the lead wires 60 of the conductive adhesive film 6 fails to tackle the sideslip problem arising from the compression of the straight slanted lead wires 60.

Similarly, when the conductive adhesive film is applied to a wafer probe card and an electrical connection interface between circuit boards, the sideslip issue also occurs.

### SUMMARY OF THE INVENTION

An objective of the present invention is to provide a conductive adhesive having multiple lead wires therein capable of cushioning a pressing force and reducing a sideslip effect on the lead wires.

To achieve the foregoing objective, the conductive adhesive has a resilient body and multiple lead wires. The resilient body has a top surface and a bottom surface. The lead wires are dispersedly mounted in the resilient body, extend from the bottom surface to the top surface of the resilient body, and are curved. Each lead wire has two end points, and a direction determined by the end points of each lead wire is perpendicular to the top surface of the resilient body.

When the conductive adhesive is applied to various IC tests and electrical connection devices, the lead wires dispersedly mounted in the resilient body are bent by a pressing force exerted by an object to be tested or connected, and the pressing force is absorbed and reduced by the lead wires. Accordingly, the resulting horizontal force component of the pressing force is lessened, and the sideslip occurring on bottom ends of the lead wires can be reduced, thereby enhancing the testing and connection stability.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a conductive adhesive having multiple curved lead wires therein in accordance with the present invention;

FIG. 2 is a perspective view of a second embodiment of a conductive adhesive having multiple curved lead wires therein in accordance with the present invention;

FIG. 3 is an enlarged side view in partial section of the conductive adhesive in FIG. 2;

FIG. 4 is a perspective view of a third embodiment of a conductive adhesive having multiple curved lead wires therein in accordance with the present invention;

FIG. 5 is a perspective view of a fourth embodiment of a conductive adhesive having multiple curved lead wires therein in accordance with the present invention;

FIG. 6 is an enlarged side view in partial section of the conductive adhesive in FIG. 5;

FIG. 7 is a side view in partial section of the conductive adhesives in FIG. 1 applied to a test for a BGA IC component;

FIG. 8 is a perspective view of multiple conductive adhesives in FIG. 1 parallelly mounted in a carrier with each conductive adhesive having multiple lead wires densely concentrated in a rectangular bar;

FIG. 9 is a perspective view of multiple conductive adhesives in FIG. 1 parallelly mounted on a carrier with each conductive adhesive having multiple lead wires discretely concentrated in a rectangular bar;

FIG. 10 is a perspective view of multiple conductive adhesives in FIG. 1 mounted alongside a perimeter of a carrier with each conductive adhesive having multiple lead wires aggregated in a rectangular bar;

FIG. 11 is a perspective view of multiple conductive adhesives in FIG. 1 mounted on a load board as a matrix with each conductive adhesive having multiple lead wires aggregated in a circle;

FIG. 12 is a side view in partial section of the conductive adhesives in FIG. 1 mounted in a carrier as a circle and applied to a test for a BGA IC component;

FIG. 13 is an operational cross-sectional view of the conductive adhesives in FIG. 1 mounted on a carrier and applied to a wafer probe card;

FIG. 14 is an operational cross-sectional view of the conductive adhesives in FIG. 1 mounted in a carrier and applied to an electrical connection element between circuit boards; and

FIG. 15 is a cross-sectional view of a conventional conductive adhesive having multiple lead wires applied to a circuit substrate and pressed down by a BGA IC component.

### DETAILED DESCRIPTION OF THE INVENTION

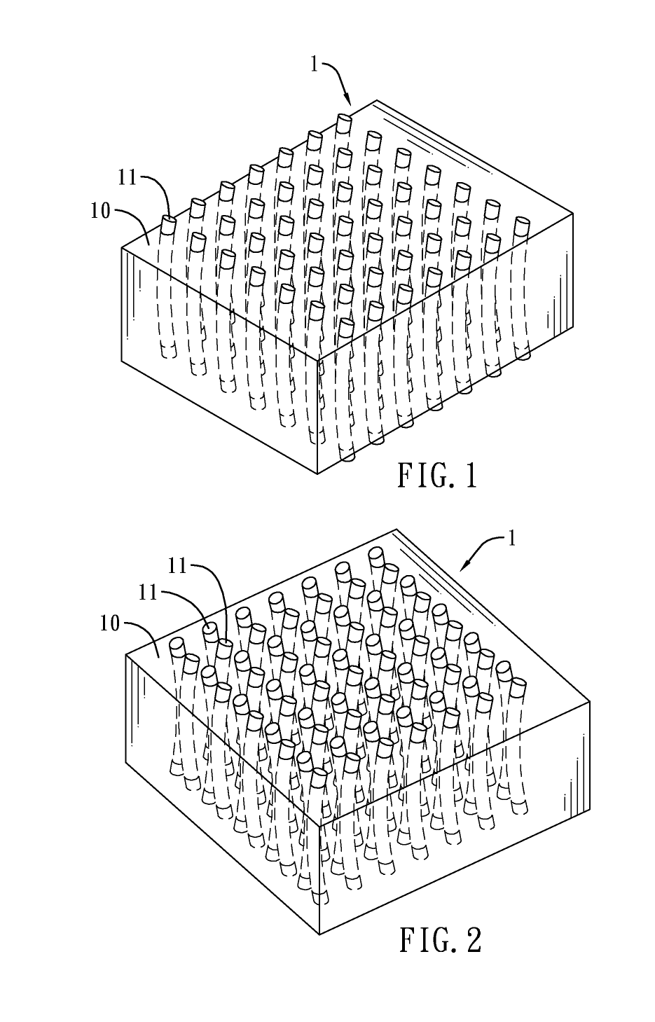

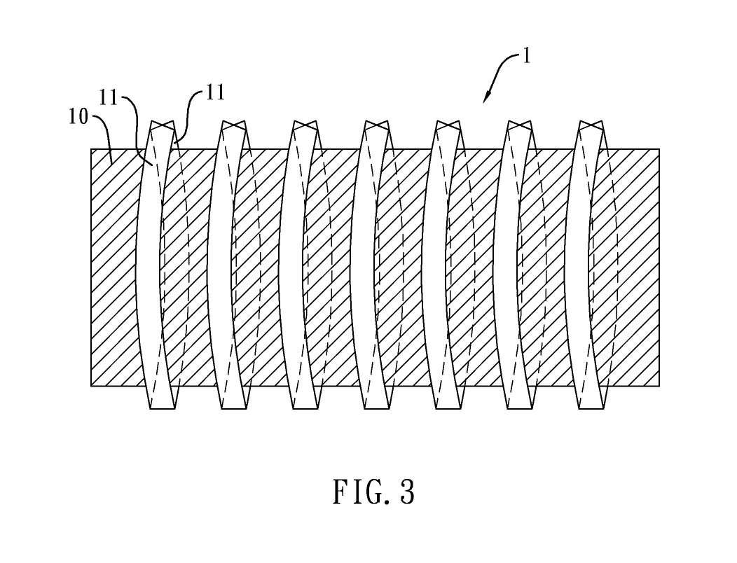

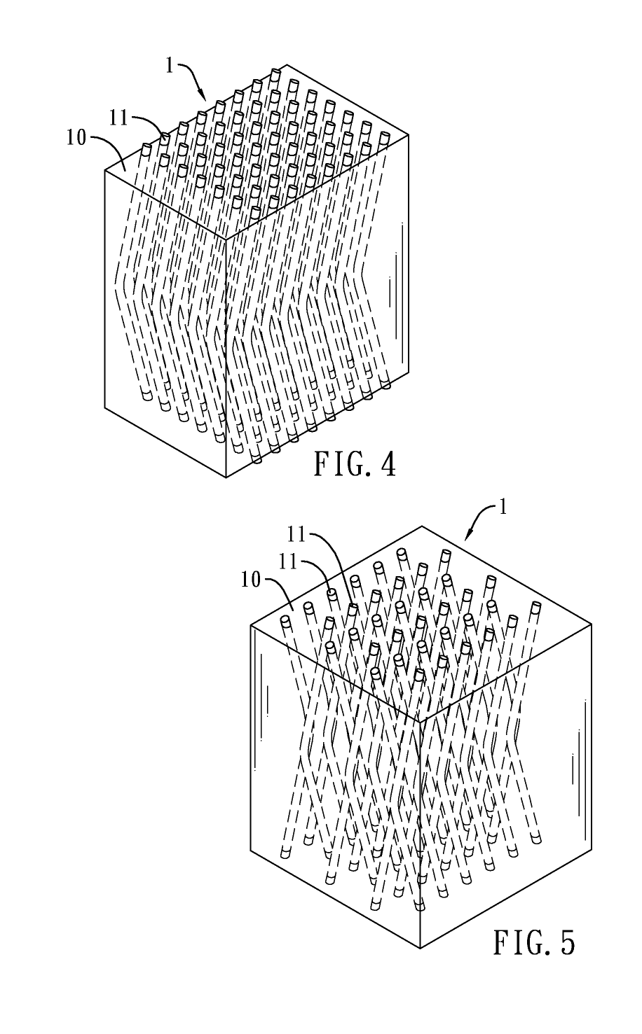

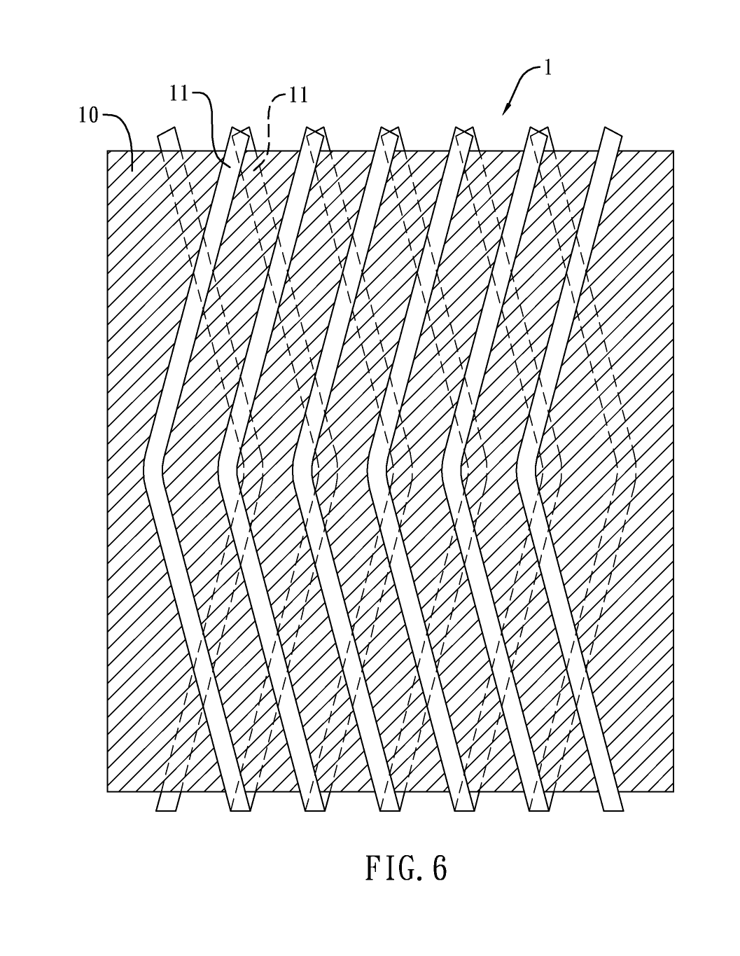

The present invention can be applied to various integrated circuit (IC) tests and electrical connection devices, such as test sockets of IC components, wafer probe cards, electrical connection interfaces of circuit boards and the like. With reference to FIGS. 1 to 6, each of several embodiments of conductive adhesives having multiple curved lead wires therein in accordance with the present invention has a resilient body 10 and multiple lead wires dispersedly mounted in the resilient body 10 and extending from a bottom surface to a top surface of the resilient body 10. The lead wires 11 may be scattered throughout the entire resilient body 10 or in a predetermined portion of the resilient body 10. For example, the conductive adhesive 1 serves as a specific portion in contact with input and output terminals, such as pins, pads, solder balls or contacts, of an object to be tested, such as an IC component or a wafer, or an object to be connected, such as a circuit board. The lead wires 11 may be arced or extends in one direction and then is deflected in another direction, and a direction determined by the end points of each lead wire 11 is perpendicular to the top surface of the resilient body 10.

For rows of lead wires 11 mounted in the resilient body 10, the lead wires 11 arranged in each row in the resilient body 10 are bent toward a same direction. The lead wires 11 in each row are bent toward a direction identical to or opposite to that toward which the lead wires 11 in an adjacent row are bent. Alternatively, the lead wires are mounted on the resilient body in multiple groups, each group has multiple adjacent rows, the lead wires mounted in each group are bent toward a same direction, the groups are divided into multiple groups one and multiple groups two alternately formed on the resilient body, the lead wires of each group one are bent toward a first direction, and the lead wires of each group two are bent toward a second direction opposite to the first direction.

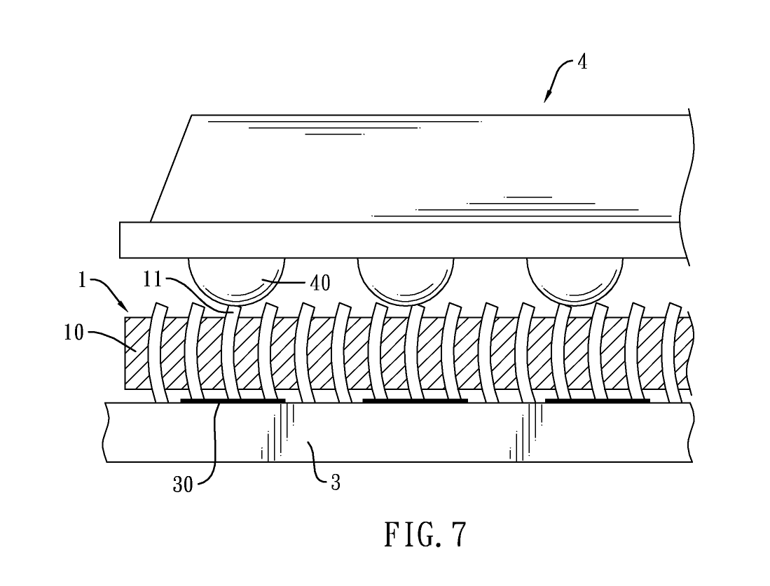

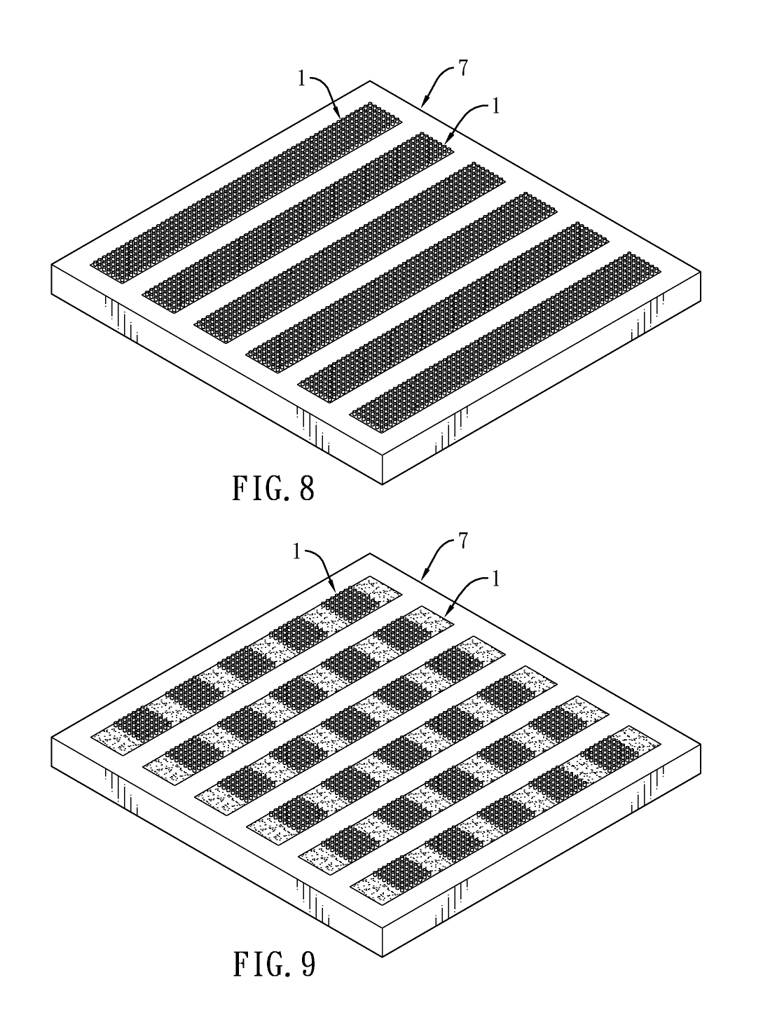

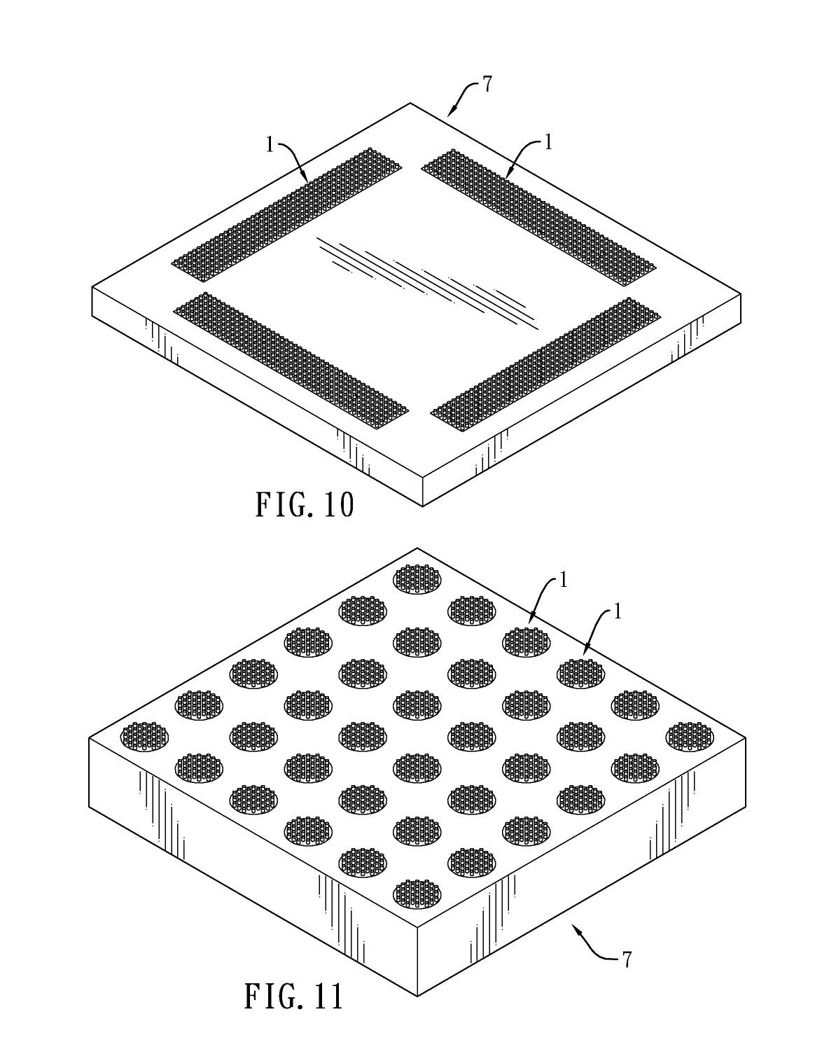

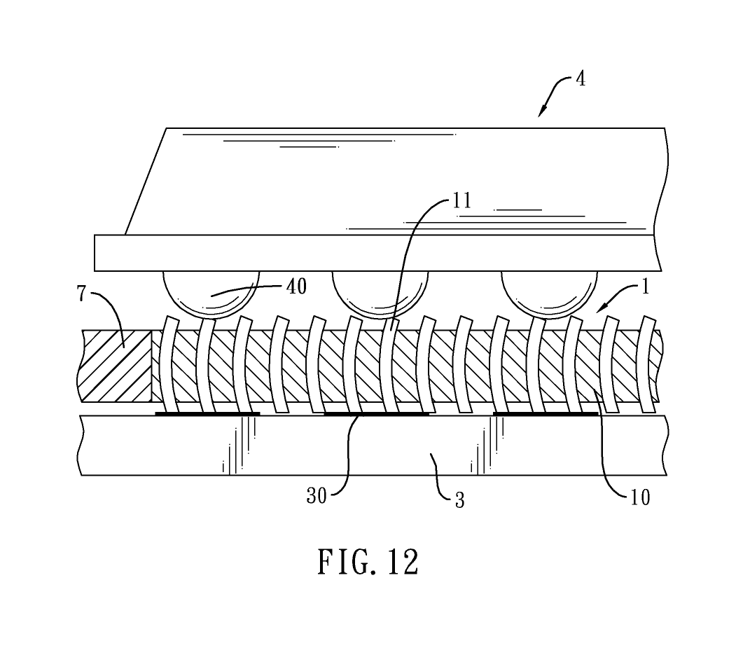

With reference to FIG. 7, a conductive adhesive 1 is sheet-shaped and large enough to contact with all input and output terminals of an object to be tested or an object to be connected. With reference to FIGS. 8 to 10, each conductive adhesive 1 is large enough, and the lead wires 11 of the conductive adhesive 1 are densely concentrated in one rectangular bar or are concentrated in the form of multiple discrete segments in one rectangular bar to contact with one row or partially contact with multiple columns of input and output terminals of an object to be tested or an object to be connected. With further reference to FIGS. 8 and 9, the rectangular bars are scattered over the entire area of the resilient body 10 of the conductive adhesive 1. With further reference to FIG. 10, the rectangular bars are so scattered that input and output terminals in a predetermined area of an object to be tested or an object to be connected contact with the lead wires 11 in the rectangular bars. With reference to FIGS. 11 and 12, each conductive adhesive is large enough so that the lead wires 11 thereof are concentrated within one circle. The lead wires 11 in each circle contact with one or multiple input and output terminals of an object to be tested or an object to be connected.

With further reference to FIG. 7, when the size of the conductive adhesive 1 is large enough to contact with all the input and output terminals of an IC component to be tested, the conductive adhesive 1 can be directly mounted on a bottom of a test socket for testing.

When each conductive adhesive 1 has the lead wires 11 arranged in a rectangular bar as shown in FIGS. 8 to 10 or arranged in a circle as shown in FIGS. 11 and 12, multiple conductive adhesives 1 can be further mounted on a carrier 7 to form an electrical connection element. With reference to FIG. 12, the conductive adhesive 1 is combined with the carrier 7 to constitute an electrical connection element in contact with all input and output terminals of an IC component to be tested, and the electrical connection element is mounted in a test socket. Furthermore, the conductive adhesive can be combined with the carrier to serve as a wafer probe card or an electrical connection interface between circuit boards.

As an example, the present invention can be applied to a test of an IC component to act as an electrical contact medium between the IC component and the load board of a test system. With reference to FIG. 7, when moved to the test socket, an IC component to be tested 4 is pressed on the conductive adhesive 1. Each of the input and output terminals 40, such as a pin, pad or solder ball, formed on a bottom of the IC component 4, contacts with a top end of a corresponding lead wire 11. A bottom end of the lead wire 11 further contacts with a corresponding pad 30. The resilient body 10 is employed to cushion the pressing force exerted by the IC component 4. Attributable to the property that the central portion of each curved lead wire 11 is easily bent and compressed when subjected to a pressing force, the lead wires 11 are bent by the pressing force exerted by the IC component 4 and the pressing force is absorbed and reduced by the lead wires 11. Since the pressing force is lessened, a resulting horizontal force component of the pressing force applied to the bottom end of each lead wire 11 is reduced accordingly, thereby effectively controlling the sideslip that occurs when the bottom end of each lead wire 11 contacts with the load board 3. In turn, the lead wires 11 have sufficient traction against the corresponding pad 30 on the load board 3 to ensure that each of the input and output terminals of the IC component 4 is correctly connected to a test system to achieve a stable test result.

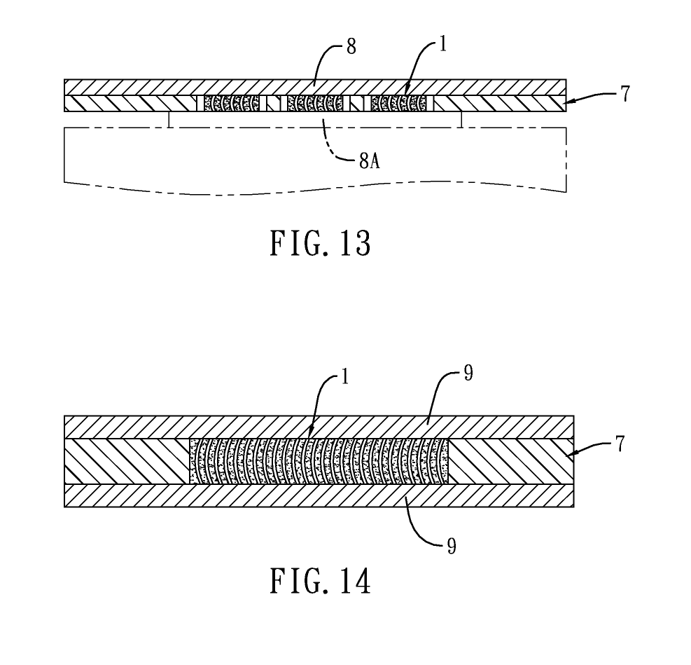

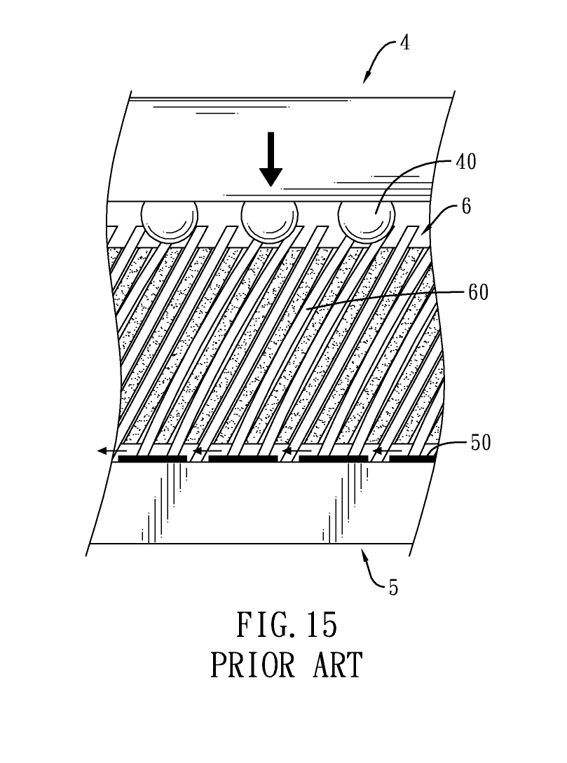

With reference to FIG. 13, the conductive adhesive 1 is mounted on a carrier 7 and is applied to a wafer probe card to serve as an electrical connection medium between a wafer 8 and a circuit board to be probed 8A. With reference to FIG. 14, the conductive adhesive 1 is mounted on a carrier 7 and is applied to serve as an electrical connection interface between circuit boards 9. During each pressing test and electrical connection, the horizontal force component of the pressing force is reduced so that the sideslip occurring on the bottom end of each lead wire is mitigated and a stable test and electrical connection can be secured.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A conductive adhesive having multiple lead wires therein, comprising:
a resilient body having a top surface and a bottom surface; and
multiple lead wires dispersedly mounted in the resilient body, extending from the bottom surface to the top surface of the resilient body, and being curved, wherein each lead wire has two end points, and a direction determined by the end points of each lead wire is perpendicular to the top surface of the resilient body.

2. The conductive adhesive as claimed in claim 1, wherein the lead wires are bent toward a same direction.

3. The conductive adhesive as claimed in claim 1, wherein the lead wires are mounted on the resilient body in multiple rows, the lead wires in each row are bent toward a first direction and the lead wires in each adjacent row are bent toward a second direction opposite to the first direction.

4. The conductive adhesive as claimed in claim 1, wherein the lead wires are mounted on the resilient body in multiple groups, each group has multiple adjacent rows, the lead wires mounted in each group are bent toward a same direction, the groups are divided into multiple groups one and multiple groups two alternately formed on the resilient body, the lead wires of each group one are bent toward a first direction, and the lead wires of each group two are bent toward a second direction opposite to the first direction.

5. The conductive adhesive as claimed in claim 1, wherein each lead wire is arced.

6. The conductive adhesive as claimed in claim 2, wherein each lead wire is arced.

7. The conductive adhesive as claimed in claim 3, wherein each lead wire is arced.

8. The conductive adhesive as claimed in claim 4, wherein each lead wire is arced.

9. The conductive adhesive as claimed in claim 1, wherein each wire extends in one direction and then is deflected in another direction.

10. The conductive adhesive as claimed in claim 2, wherein each wire extends in one direction and then is deflected in another direction.

11. The conductive adhesive as claimed in claim 3, wherein each wire extends in one direction and then is deflected in another direction.

12. The conductive adhesive as claimed in claim 4, wherein each wire extends in one direction and then is deflected in another direction.
